(19) United States
(12) Patent Application Publication
(10) Pub. No.: US 2006/0245136 A1
(43) Pub. Date: Nov. 2, 2006

(54) Temperature-detecting and control circuit

(75) Inventors: Chien-Lung Chang, Taipei (TW); Kuo-Chung Kao, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer, Inc.

(21) Appl. No.: 11/273,185

(22) Filed: Nov. 14, 2005

(30) Foreign Application Priority Data
Apr. 29, 2005 (TW) 94114007

(51) Int. Cl. H02H 5/04

(52) U.S. Cl. 361/103

(57) ABSTRACT

A temperature detecting and control circuit with a first voltage dividing circuit, a second voltage dividing circuit, a fan rotary speed controller, and a comparator is described. The first voltage dividing circuit generates a first voltage. The second voltage dividing circuit generates a second voltage. The second voltage dividing circuit has a temperature sensitive element for detecting the temperature of hardware. The comparator compares the first voltage with the second voltage and then outputs the result to the fan rotary speed controller. When the fan rotary speed controller receives a first fan control signal, the fan is maintained at a first rotary speed. When the fan rotary speed controller receives a second fan control signal, the fan is maintained at a second rotary speed.

### RELATED APPLICATIONS

The present application is based on, and claims priority from, Taiwan Application Serial Number 94114007, filed Apr. 29, 2005, the disclosure of which is hereby incorporated by reference herein in its entirety.

### FIELD OF THE INVENTION

The present invention relates to a temperature detecting and control circuit, and more particularly, relates to a temperature detecting and control circuit applied in a computer system.

### BACKGROUND OF THE INVENTION

Currently, computers are designed to be as small as possible, with increasingly fast operation speeds. Waste heat generated by electronic devices in a small volume creates surges in the operational temperature of a computer. This situation reduces the operating efficiency of the computer system, or may damage devices therein. Accordingly, computer operation temperature control is vital to the functionality of the computer.

A traditional graphic card in a computer system usually processes image data at a high speed and generates heat easily. To control the operation temperature of the computer system, a temperature-detecting chip is used to detect the operation temperature, and a fan is used to dissipate waste heat. However, the temperature detecting-chip and a plus width modulation (PWM) circuit used for controlling the rotation of the fan are very expensive, and the temperature detected by the chip generally is imprecise.

Furthermore, a conventional graphic card, such as that provided by Nvidia® and ATI® usually has a graphic processing unit (GPU) circuit and a memory device circuit. Only the GPU circuit has a voltage control function for controlling operation voltages thereof, either to increase the operation effectiveness or to generate less noise.

### SUMMARY OF THE INVENTION

One aspect of the present invention provides a temperature-detecting and control circuit with simpler and cheaper devices to control the dissipation of waste heat in an electronic unit.

The second aspect of the present invention provides a temperature-detecting and control circuit that informs the operators whether a graphic card set in an electronic unit is operating within an allowable temperature.

The third aspect of the present invention provides a temperature-detecting and control circuit having a fan rotary controller that can accomplish the requirements of making the fan generate less noise and dissipate heat more efficiently.

The fourth aspect of the present invention provides a temperature-detecting and control circuit having a fan rotary controller used to control a fan rotating in two rotary speed by a voltage dividing method. The controller merely consists of several transistor and resistors, which can approach its desired functions in a chipper way.

The fifth aspect of the present invention provides temperature-detecting and control circuit that can provide both a GPU circuit and a memory device circuit that are set in the same electronic unit to control the working voltages for either increasing the operation speed or decreasing heat generating of the same.

In accordance with aforementioned aspects, the temperature detecting and control circuit provided by a preferred embodiment comprises a first voltage dividing circuit, a second voltage dividing circuit, a fan rotary controller and a comparator. The first voltage dividing circuit receives a power source and outputs a first voltage. The second voltage dividing circuit receives the power source and outputs a second voltage. The second voltage dividing circuit has a temperature sensitive element, used to detect the temperature of an electronic unit. The resistance of the temperature sensitive element changes while the temperature of the electronic device changes, and triggers the second voltage to change.

The comparator is used for comparing the first voltage with the second voltage. When the second voltage is greater than the first voltage, the comparator outputs a third voltage; conversely, the comparator outputs a fourth voltage when the second voltage is smaller than the first voltage. The third voltage then is transformed into a first fan control signal and the fourth voltage is transformed into a second fan control signal.

The fan rotary controller is used for controlling the rotary speed of the fan to dissipate heat generated by the computer system. When the third voltage or the first fan control signal is received, the fan rotates at a first rotary speed. Alternatively, when the fourth voltage or the second fan control signal is received, the fan rotates at a second rotary speed.

In some embodiments of the present invention, the fan rotary controller comprises a transistor and a resistor. The source of the transistor is grounded, the drain of the transistor is electrically connected to the fan, and the gate of the transistor is used for receiving the first fan control signal and the second fan control signal.

The transistor turns on when the gate receives the first fan control signal, and the transistor turns off when the gate receives the second fan control signal.

In accordance with the aspects of the present invention, a temperature detecting and control circuit for used to a graphic card is provided. In a preferred embodiment of the present invention, the temperature detecting and control circuit comprises a first dividing voltage circuit, a second dividing voltage circuit, and a comparator. The first voltage dividing circuit receives a power source and outputs a first voltage, and the second voltage dividing circuit receives the power source and outputs a second voltage. The second dividing voltage circuit has an electronic temperature sensitive element for detecting the temperature of the graphic card. When the temperature changes, the resistance of the electronic temperature sensitive element varies to trigger the second voltage changes simultaneously.

The comparator receiving the first voltage and the second voltage is used for comparing the first voltage with the second voltage. When the second voltage is greater than the first voltage, the comparator outputs a third voltage; conversely, when the second voltage is smaller than the first voltage, the comparator outputs a fourth voltage.

The graphic card further comprises a memory power circuit, by which the voltages output from the comparator can be transformed into a memory voltage control signal. The memory voltage control signal then is transferred to a gate of a transistor. The transistor electrically connects with the memory power circuit by a resistor.

Accordingly, the advantages of temperature detecting and control circuit provided by the present invention are as follows.

The first advantage is that the temperature detecting and control circuit can simplify the process for controlling the temperature of an electronic unit. The second advantage is that the temperature detecting and control circuit can inform the operator whether a graphic card set in a computer system operates within a allowable temperature to prevent the graphic card from being burned out. The third advantages is that the temperature detecting and control circuit has a fan rotary controller that can accomplish the requirements of making the fan generating less noise and dissipating heat more efficiently. The fourth advantage is that the temperature detecting and control circuit having a fan rotary controller is used to control a fan rotating in two rotary speeds by a voltage dividing method. The controller merely consists of several transistor and resistors, which can approach the desired functions in a chipper way. The fifth advantage is that the temperature detecting and control circuit providing voltage controlling functions for both a GPU power circuit and a memory power circuit set in the same GPU to control their working voltages for either increasing the operation speed or decreasing heat generation of the same.

It should be noted that every embodiment has at least one advantage and not necessarily all of them.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawing, wherein:

FIG. 1 is a functional diagram illustrating the functions of the temperature detecting and control circuit, in accordance with one preferred embodiment of the present invention.

FIG. 2 is a circuit diagram illustrating the circuit arrangement of the temperature detecting and control circuit, in accordance with the first preferred embodiment of the present invention.

FIG. 3 is a circuit diagram illustrating the circuit arrangement of the temperature detecting and control circuit, in accordance with the second preferred embodiment of the present invention.

FIG. 4 is a circuit diagram illustrating the circuit arrangement of a fan rotary controller, in accordance with one preferred embodiment of the present invention.

FIG. 5 is a circuit diagram illustrating the circuit arrangement of a fan rotary controller, in accordance with another preferred embodiment of the present invention.

FIG. 6 is a circuit diagram illustrating the circuit arrangement of a voltage control circuit of a GPU power circuit and a memory power circuit, in accordance with one preferred embodiment of the present invention.

### DETAILED DESCRIPTION OF THE PREFERRED EMBODIMENT

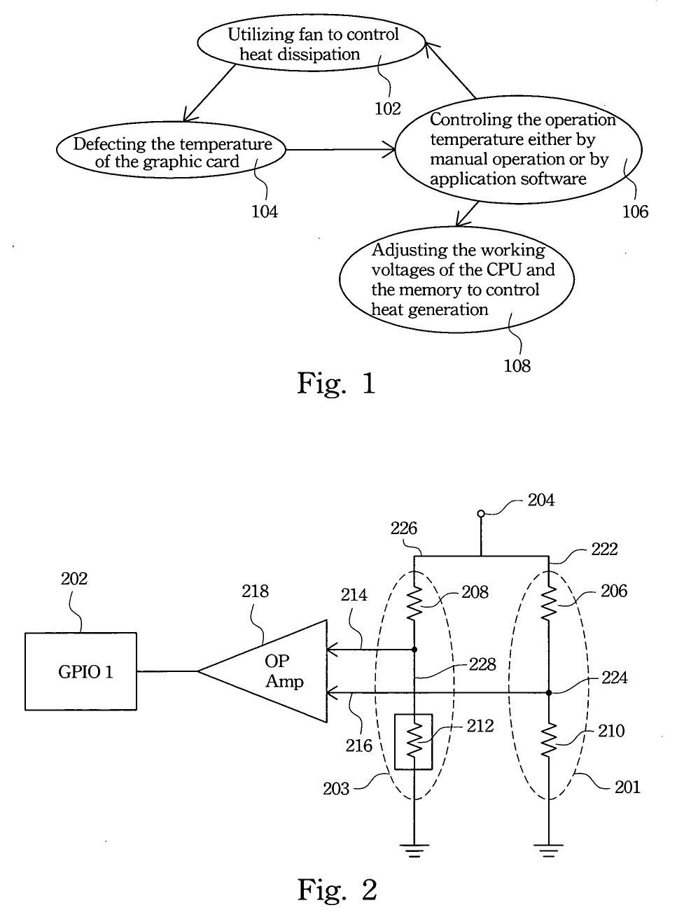

FIG. 1 is a functional diagram illustrating the functions of the temperature detecting and control circuit, in accordance with one preferred embodiment of the present invention.

Referring to stage 104, a temperature of an electronic unit, such as a graphic card set in a computer system, is detected by the temperature detecting and control circuit. Next, the temperature detecting and control circuit is controlled, either by manual operation or by application software (referring to stage 106). Then, the operation temperature is controlled via utilizing a fan rotating at various speeds for controlling the heat dissipation (referring to stage 102) or adjusting the working voltages of the graphic card and a memory for controlling heat generation (referring to stage 108).

FIG. 2 is a circuit diagram illustrating the circuit arrangement of the temperature detecting and control circuit, in accordance with the first preferred embodiment of the present invention. In the circuit diagram, a first dividing circuit 201 receives a power source 204 and outputs a first voltage 216. A second dividing circuit 203 receives the power source 204 and outputs a second voltage 214. The second voltage dividing circuit 203 has a temperature sensitive element 212 used to detect the temperature of an electronic unit. The temperature sensitive element 212 is set close to the electronic unit to be detected or the location close to a heat generator. For example, the temperature sensitive element 212 is set on the back surface of a GPU. The resist of the temperature sensitive element 212 changes while the temperature of the electronic unit changes, and triggers the second voltage 214 to change.

A comparator 218 is used for comparing the first voltage 216 with the second voltage 214. When the second voltage 214 is greater than the first voltage 216, the comparator 218 outputs a third voltage; conversely, the comparator 218 outputs a fourth voltage when the second voltage 214 is smaller than the first voltage 216. The outputs of the comparator 218 (either the third voltage or the fourth voltage) are transferred to an electronic unit, such as a graphic card, by a first general purpose input output (GPIO |). The third voltage is then transformed into a first fan control signal, and the fourth voltage is transformed into a second fan control signal respectively. The fan control signal (either the first fan control signal or the second fan control signal) is then transferred to a fan rotary controller via a second general purpose input output (GPIO ∥).

In one embodiment of the present invention, the first dividing voltage circuit 201 comprises a first resistor 206 and a second resistor 210. One end 222 of the first resistor 206 electrically connects to the power source 204. The first end 224 of the second resistor 210 electrically connects to the first resistor 206, and the second end of the second resistor 210 is grounded. The first voltage is output from the first end 224 of the second resistor 210.

In one embodiment of the present invention, the second dividing voltage circuit 203 comprises a third resistor 208 and the temperature sensitive element 212. One end 226 of the third resistor 208 electrically connects to the power source 204. The first end 228 of the temperature sensitive element 212 electrically connects to the third resistor 208, and the second end of the temperature sensitive element 212 is grounded. The second voltage is output from the first end 228 of the temperature sensitive element 212. For example, the temperature sensitive element 212 is a thermistor, and the comparator 218 is an operational amplifier. When the temperature of an electronic unit to be detected surges, the resistance of the thermistor increases. When the resistance of the thermistor increases, the third voltage is greater than the fourth voltage.

In the present embodiment, when the third voltage is output from the comparator 218, an alarm signal is displayed on a displayer. Alternatively when the fourth voltage is output from the comparator 218, a signal indicating a normal situation is displayed on the displayer. Although the displayer merely displays two situations of pass or fail, rather than the exact temperature, the operators of the graphic card still can be informed whether the electronic unit is operating in an allowable temperature, such that this design can significantly reduce the manufacturing cost.

Furthermore, when the temperature of the graphic card cannot be reduced to the allowable situation by a fan rotating at full speed, the electronic apparatus that has the graphic card is shut down to prevent the graphic card from burning out. In this way, the operators can indirectly indicate whether the fan is in a normal situation.

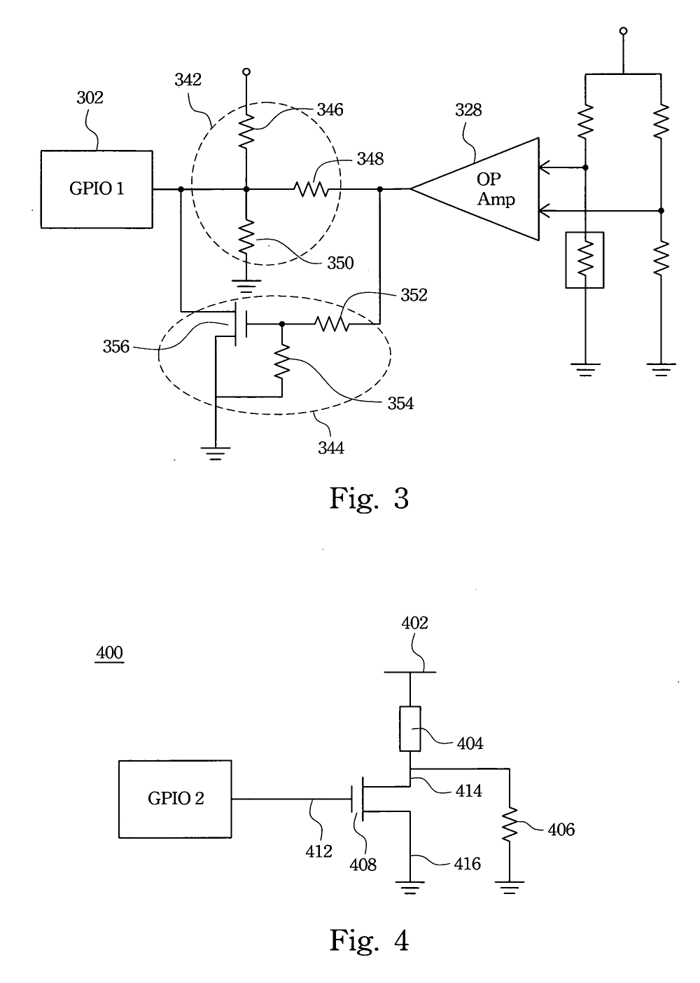

FIG. 3 is a circuit diagram illustrating the circuit arrangement of the temperature detecting and control circuit, in accordance with the second preferred embodiment of the present invention. The circuit illustrated in FIG. 3 is similar to that of FIG. 2, but is different by a voltage-adjusting circuit 342 and an inverter circuit 344 involved in FIG. 3. Referring to FIG. 3, the GPIO 1302 requires a particular specification for a input voltage, such that several kinds of circuit, such as the voltage-adjusting circuit 342 and the inverter circuit 344, are desired to transform the voltages from the comparator 328 into voltages compliant with the specification.

In present embodiment, the voltage adjust circuit 342 has resistors 346, 348, and 350. The inverter circuit 344 has a transistor 356 and resistors 352 and 354. For this circuit arrangement, when the voltage-adjusting circuit 342 is in use, the inverter circuit can be abandoned, but when the inverter circuit 344 is in use, the resistors 346 and 350 are also needed.

FIG. 4 is a circuit diagram illustrating the circuit arrangement of a fan rotary controller, in accordance with one preferred embodiment of the present invention. The fan rotary controller 400 is used to control a fan 404 for dispersing heat from an electronic unit, such as a graphic card. When the fan rotary controller 400 receives a first fan control signal, the fan 404 rotates at a first rotary speed. Alternatively, when the fan rotary controller 400 receives a second fan control signal, the fan 400 rotates at a second rotary speed.

The fan 404 rotating at a higher speed can disperse more heat but generates more noise. Conversely, rotating at a higher speed generates less noise but disperses less heat. The designer of the fan rotary controller 400 must balance the requirement for heat dissipation against the requirement for noise elimination.

The fan rotary controller 400 comprises a transistor 408 and a resistor 406. The source 416 of the transistor 408 is grounded, the drain 414 of the transistor 408 is electrically connected to the fan 404, and the gate 412 is used for receiving the first fan control signal or the second fan control signal.

The first end of the resistor 406 is electrically connected to the drain 414 of the transistor 408, and the second end of the resistor 406 is grounded. When the gate 412 of the transistor 408 receives the first fan control signal, the transistor 408 should be turned on and a first electric current from the power source 402 of flows through the fan 404 and the drain 414 of the transistor 408. When the gate 412 of the transistor 408 receives the second fan control signal, the transistor 408 is turned off, and a second electric current from the power source of 402 flows through the fan 404 and the resistor 406. The switch between the first current and the second current can change the dividing voltage of the fan 404 and the resistor 406. When the dividing voltage of the fan is decreased, the electric power received by the fan is reduced, so that the fan rotates more slowly, or, conversely, rotates more quickly.

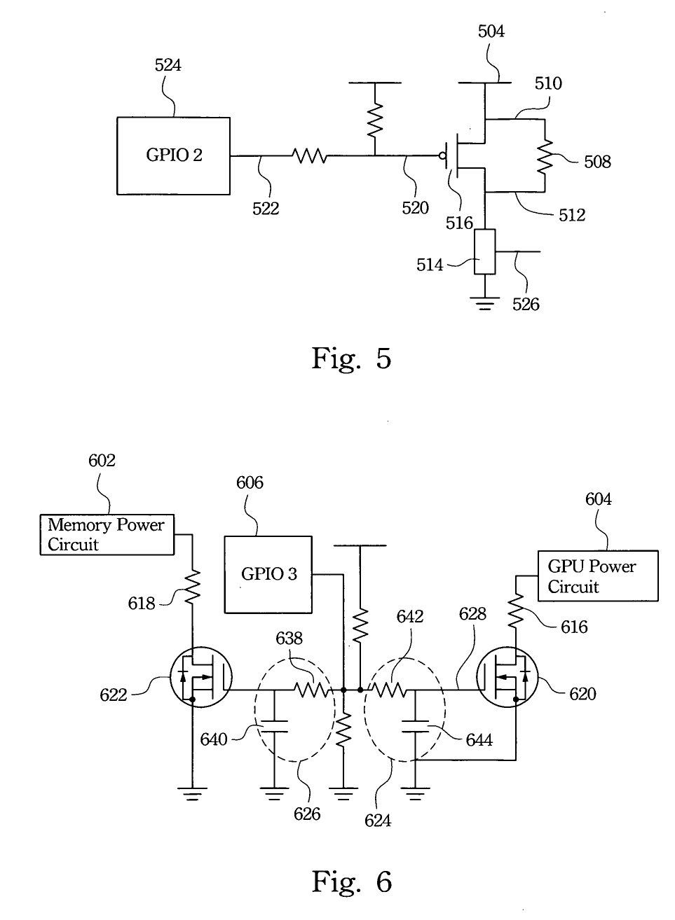

FIG. 5 is a circuit diagram illustrating the circuit arrangement of a fan rotary controller, in accordance with another preferred embodiment of the present invention. The drain of a transistor 516 is electrically connected to the fan 514, the source of the transistor 516 is electrically connected to a power source 504, and the gate 520 of the transistor 516 is used for receiving a first fan control signal or a second fan control signal. The first end 510 of a resistor 508 is electrically connected to the source of the transistor 516, and the second end 512 of the resistor 508 is electrically connected to the drain of the transistor 516. When the gate 520 of the transistor 516 receives the first fan control signal, the transistor 516 is turned off, and a first electric current from the power source 504 flows through the fan 514 and the resistor 508. When the first electric current flows through the fan 514 and the resistor 508, the dividing voltage of the fan 514 and the resistor 508 are varied, and the electric power received by the fan 514 is reduced, so its rotary speed is slower. When the gate 520 of the transistor 516 receives the second fan control signal, the transistor 516 is then turned on, and a second electric current from the power source 504 flows through the fan 514 and the transistor 516. When the second electric current flows through the fan 514 and the transistor 516, the dividing voltage of the fan 514 is varied, and the electric power received by the fan 514 is increased, so that its rotary speed is quicker.

FIG. 6 is a circuit diagram illustrating the circuit arrangement of a voltage control circuit of a GPU power circuit and a memory power circuit, in accordance with one preferred embodiment of the present invention. In the present embodiment the GPU power circuit 604 and the memory power circuit 602 are involved in a GPU. When the voltages of the GPU power circuit 604 and the memory power circuit 602 are increased, the operation speed of the GPU increases more efficiently. When the voltages of the GPU power circuit 604 and the memory power circuit 602 are decreased, heat generated by the GPU is certainly reduced.

A signal output by a comparator (such as comparator 218 shown in FIG. 2) is transformed into a GPU voltage control signal or a memory voltage control signal. Then the GPU voltage control signal is transferred to the gate 628 of a first transistor 620, and the memory voltage control signal is transferred to the gate of a second transistor 622 via a GPIO |∥ 606, respectively. A first resistor 616 connects the GPU power circuit 604 with the drain of the first transistor 628. A second resistor 618 connects the memory power circuit 602 with the drain of the first transistor 622. In the present embodiment, the GPU voltage control signal and the memory voltage control signal come from the same source (comparator 218).

A soft starter 624 comprising a resistor 642 and a capacitor 644 is set between the comparator and the first transistor 620. Similarly, another soft starter 626 having a resistor 638 and a capacitor 640 can be set between the comparator and the second transistor 622. The transistor 622 can be turned on via the memory voltage control signal transferred from the GPIO |∥ 606 making resistor 618 parallel connected to the memory power circuit 602 to change the voltage of the memory power circuit 602, while the transistor 620 can be turned on via the GPU voltage control signal transferred from the GPIO |∥ 606 making resistor 616 parallel connected the GPU power circuit 604 to change the voltage of the GPU power circuit 604. Conversely, the transistor 622 and 620 can be turned off to change the voltages of the GPU power circuit 604 and memory power circuit 602, respectively. The soft starters 624 and 626 serve as buffers to prevent the operation software, such as Microsoft Window, from being shut down due to the rapidly fluctuating voltages.

According to the detailed description of the invention, a simple and chipper assembly of devices can be used to accomplish the functions provided by traditional temperature detecting and control circuit. The present temperature detecting and control circuit has a function to inform an operator whether the operation temperature is normal. Furthermore, the temperature detecting and control circuit has a fan rotary controller that can balance the requirements of the fan to generate less noise and dissipate heat more efficiently. The temperature detecting and control circuit having a fan rotary controller used to control a fan rotating in two rotary speed by a voltage dividing method. The controller merely consists of several transistors and resistors, which can approach the desired functions in chipper ways. The temperature detecting and control circuit has voltage controlling functions providing both a GPU power circuit and a memory power circuit set in the same graphic card to control the working voltages, either for increasing the operation speed or for decreasing heat generation of the same.

As is understood by a person skilled in the art, the foregoing preferred embodiments of the present invention are illustrative, rather than limiting, of the present invention, and are intended to cover various modifications and similar arrangements included within the spirit and scope of the appended claims, the scope of which should be accorded the broadest interpretation so as to encompass all such modifications and similar structures.

What is claimed is:

1. A temperature detecting and control circuit, comprising:
a first dividing circuit, receiving a first power source and outputting a first voltage;
a second dividing circuit, receiving the first power source and outputting a second voltage, wherein the second dividing circuit has a temperature sensitive element for detecting a temperature of an electronic unit, when the detected temperature changes, a resistance of the temperature sensitive element varies to trigger the second voltage changes, simultaneously;
a comparator, receiving the first voltage and the second voltage, when the second voltage is greater than the first voltage, the comparator outputs a third voltage, or conversely, when the second voltage is smaller than the first voltage, the comparator outputs a fourth voltage; and
a fan rotary controller, for controlling a fan to disperse heat generated from the electronic unit, wherein when the fan rotary controller receives a first fan control signal transformed by the third voltage, the fan rotates at a first rotary speed, and when the fan rotary controller receives a second fan control signal transformed from the fourth voltage, the fan rotates at a second rotary speed.

2. The temperature detecting and control circuit in accordance with claim 1, wherein the first dividing voltage circuit further comprises:
a first resistor, having one end electrically connected to the first power source; and
a second resistor, having a first end and a second end, wherein the first end electrically connected to the first resistor is used to output a first voltage, and the second end is grounded.

3. The temperature detecting and control circuit in accordance with claim 1, wherein the second dividing voltage circuit further comprises a third resistor electrically connected to the first power source and the temperature sensitive element made of a thermistor, wherein a first end of the temperature sensitive element used to output a second voltage connects to the third resistor, and a second end of the temperature sensitive element is grounded.

4. The temperature detecting and control circuit in accordance with claim 1, wherein the fan rotary controller comprises:
a transistor, wherein a source of the transistor is grounded, a drain of the transistor is electrically connected to the fan, and a gate of the transistor is used for receiving the first fan control signal and the second fan control signal; and
a resistor, having a first end and a second end, wherein the first end electrically connects to the drain of the transistor, and the second end connects to the ground,
when the gate of the transistor receives the first fan control signal, the transistor is turned off, and a first electric current from the first power source flows through the fan and the resistor, and when the gate of the transistor receives the second fan control signal, the transistor is turned on, and a second electric current from the fist power source flows through the fan and the transistor.

5. The temperature detecting and control circuit in accordance with claim 1, wherein the fan rotary controller comprises:
a transistor, wherein a drain of the transistor is electrically connected to the fan, a source of the transistor is electrically connected to a second power source and a gate of the transistor is used for receiving the first fan control signal and the second fan control signal; and
a resistor, having a first end electrically connected to the source of the transistor, and a second end electrically connected to the drain of the transistor;
wherein when the gate of the transistor receives the first fan control signal, the transistor is turned off, and a first electric current from the second power source flows through the fan and the resistor, and when the gate of the transistor receives the second fan control signal, the transistor is turned on, and a second electric current from the second power source flows through the fan and the transistor.

6. The temperature detecting and control circuit in accordance with claim 1, further comprising a displayer, wherein when the comparator outputs the third voltage, an alarm signal is displayed on the displayer, and when the comparator outputs the fourth voltage, a signal indicating a normal situation is displayed on the displayer.

7. The temperature detecting and control circuit in accordance with claim 1, wherein the electronic unit is a graphic card comprising a memory power circuit having a first transistor and a first resistor, and a graphic processing unit (GPU) power circuit having a second resistor and a second resistor, wherein a gate of the first transistor connects to the comparator, a drain of the first resistor connects the drain of the first transistor with the memory power circuit, a gate of the second transistor connects to the comparator, and a drain of the second resistor connects the drain of the second transistor with the GPU power circuit, and when a signal from the comparator is transformed into a first voltage control signal by a first transistor, the first voltage control signal is then transferred to the memory power circuit, and when a signal from the comparator is transformed into a second voltage signal by a second transistor, the second voltage signal is then transferred to the GPU power circuit.

8. The temperature detecting and control circuit in accordance with claim 7, further comprising a first soft start circuit set between the comparator and the first transistor, wherein the first soft start circuit comprises a transistor and a capacitor.

9. The temperature detecting and control circuit in accordance with claim 7, further comprising a second soft start circuit set between the comparator and the second transistor, wherein the second soft start circuit comprises a transistor and a capacitor.

10. A temperature detecting and control circuit, for detecting and controlling a temperature of a graphic card, the temperature detecting and control circuit comprising:
a first dividing circuit, for receiving a first power source and outputting a first voltage;
a second dividing circuit, for receiving the first power source and outputting a second voltage, wherein the second voltage circuit has a temperature sensitive element for detecting a temperature of the graphic card, and when the detected temperature changes, a resistance of the temperature sensitive element varies to trigger the second voltage changes, simultaneously; and
a comparator, for receiving the first voltage and the second voltage, when the second voltage is greater than the first voltage, the comparator outputs a third voltage, or conversely, when the second voltage is smaller than the first voltage, the comparator outputs a fourth voltage;
wherein the comparator comprises a memory power circuit having a first transistor and a first resistor, wherein a gate of the first transistor connects to the comparator, a drain of the first resistor connects the drain of the first transistor with the memory power circuit, and when a signal from the comparator is transformed into a first voltage control signal by a first transistor, the first voltage control signal is then transferred to the memory power circuit.

11. The temperature detecting and control circuit in accordance with claim 10, further comprising a first soft start circuit set between the comparator and the first transistor, wherein the first soft start circuit comprises a transistor and a capacitor.

12. The temperature detecting and control circuit in accordance with claim 10, further comprising a fan rotary controller, for controlling a fan to disperse heat generated from the graphic card, when the fan rotary controller receives a first fan control signal, the fan rotates at a first rotary speed, and when the fan rotary controller receives a second fan control signal, the fan rotates at a second rotary speed.

13. The temperature detecting and control circuit in accordance with claim 12, wherein the fan rotary controller comprises:
a second transistor, wherein a source of the second transistor is grounded, a drain of the second transistor is electrically connected to the fan, and a gate of the second transistor is used for receiving the first fan control signal and the second fan control signal; and
a second resistor, having a first end and a second, wherein the first end electrically connects to the drain of the second transistor, and the second end connects to the ground;
when the gate of the transistor receives the first fan control signal, the transistor is turned off, and a first electric current from a second power source flows through the fan and the resistor, when the gate of the transistor receives the second fan control signal, the transistor is turned on, and a second electric current from the second power source flows through the fan and the transistor.

14. The temperature detecting and control circuit in accordance with claim 12, wherein the fan rotary controller comprises:
a second transistor, wherein a drain of the second transistor is electrically connected to the fan, a source of the second transistor is electrically connected to a second power source and a gate of the second transistor is used for receiving the first fan control signal and the second fan control signal; and
a second resistor, having a first end and a second end, wherein the first end is electrically connected to the source of the second transistor, and the second end is electrically connected to the drain of the second transistor;
wherein when the gate of the second transistor receives the first fan control signal, the second transistor is turned off, and a first electric current from the second power source flows through the fan and the second resistor, and when the gate of the second transistor receives the second fan control signal, the second transistor is turned on, and a second electric current from the second power source flows through the fan and the second transistor.

15. The temperature detecting and control circuit in accordance with claim 10, wherein the first dividing voltage circuit further comprises:
a third resistor, having one end electrically connected to the first power source; and
a fourth resistor, having a first end and a second end, wherein the first end electrically connected to the third resistor is used to output a first voltage, and the second end is grounded.

16. The temperature detecting and control circuit in accordance with claim 10, wherein the second dividing voltage circuit further comprises a fifth resistor electrically connected to the first power source and the temperature sensitive element made of a thermistor, wherein a first end of the temperature sensitive element connected to the fifth resistor is used to output a second voltage, and a second end of the temperature sensitive element is grounded.

17. The temperature detecting and control circuit in accordance with claim 10, wherein the comparator is an operational amplifier.

18. The temperature detecting and control circuit in accordance with claim 10, further comprising a displayer, wherein when the comparator outputs the third voltage an alarm signal is displayed on a displayer, and while the comparator outputs the fourth voltage, an signal indicating a normal situation is displayed on the displayer.

19. The temperature detecting and control circuit in accordance with claim 10, wherein the graphic card comprises a GPU power circuit having a third transistor and a sixth resistor, the gate of the third transistor connects to the comparator, the drain of the sixth resistor connects the drain of the third transistor with the GPU power circuit, and when a signal from the comparator is transformed into a second voltage signal by a third transistor, the second voltage signal is then transferred to the GPU power circuit.

20. The temperature detecting and control circuit in accordance with claim 10, further comprising a second soft start circuit set between the comparator and the third transistor, wherein the second soft start circuit comprises a transistor and a capacitor.
